(19) United States
(12) Patent Application Publication
(10) Pub. No.: US 2009/0238525 A1
(43) Pub. Date: Sep. 24, 2009

(54) PRODUCTION METHOD OF PREFORM OF PLASTIC OPTICAL MEMBER AND PLASTIC OPTICAL FIBER

(75) Inventors: Kosuke Yamaki, Shizuoka (JP); Yukio Shirokura, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Tokyo (JP)

(21) Appl. No.: 11/910,262

(22) PCT Filed: Mar. 28, 2006
(86) PCT No.: PCT/JP2006/307017

§ 371 Date: Sep. 29, 2007

(30) Foreign Application Priority Data
Mar. 31, 2005 (JP) 2005-102916

(51) Int. Cl. G02B 6/032; C03B 37/027

(52) U.S. Cl. 385/125; 65/393

(57) ABSTRACT

Polymerizable composition, whose main component is MMA, is injected into a clad tube (12) of PVDF. Then the clad tube (12) is inserted into a polymerization reactor (33). Three heaters (35a to 35c) are arranged along the longitudinal direction of the polymerization reactor (33). The set temperature of the heater (35a) at the left is 56° C., that of the heater (35b) at the center is 58° C., and that of the heater (35c) at the right is 60° C. The polymerization reaction is performed with rotating drive rolls (34) at 500 rpm to 3000 rpm. As a result, an inner clad layer (40) with constant thickness, whose main component is PMMA, is formed. A core (41) is formed inside the inner clad layer (40) to obtain a preform (16). The preform (16) is drawn to be a POF (18) having a constant diameter.

### TECHNICAL FIELD

The present invention relates to a production method of a preform of plastic optical member and a plastic optical fiber obtained by heat-drawing the preform produced from this production method.

### BACKGROUND ART

As having merits in easiness of processing and production, low price and the like, plastic optical member, compared with an optical member of quartz having the same structure, is recently utilized for several members, such as an optical fiber, an optical lens, an optical waveguide and the like. Especially the plastic optical fiber among these members is entirely made of plastic. Therefore the plastic optical fiber has merits in adequate flexibility, smaller weight and more easy treatment and production as the optical fiber having large diameter, and the lower production cost than the quartz optical fiber, although having demerit in larger transmission loss than the optical member of quartz. In Japanese Patent Laid-Open Publication No. S61-130904, it is planned to use several sorts of the plastic optical fibers as transmitting mediums for such a short distance transmission that the transmission loss is not so large to an influence on the transmission.

The plastic optical fiber (hereinafter, POF) is constructed of a core whose main component is organic compounds in which polymer molecules are arranged in matrix, a clad composed of organic materials having different refractivity from the core. (The clad usually has a low refractive index). Especially, there is a POF of refractive index distribution type in which the core has refractive index distribution from the center toward the outside. In this structure, the band for transmission of the optical signal is able to be made larger. Therefore, this type of the plastic optical fiber has high transmission capacity and attracts attention to use for the high transmission. Several methods of producing the optical member of the refractive index distribution type are proposed, and for example in Japanese Patent Publication No. 3332922 and Japanese Patent Laid-Open Publications No. H10-246821 and 2001-215345, there is a method in which interfacial gel polymerization is made to form a preform, and the preform is drawn to produce the graded index plastic optical fiber (hereinafter, GI-POF). When producing the POF in this drawing process, it is possible to cause long-period variation in the diameter of the POF. To reduce the diameter variation, Japanese Patent Laid-Open Publication No. H11-337745 determines conditions of a heat-drawing process and a cooling process.

In the Japanese Patent Laid-Open Publications No. H10-246821 and 2001-215345, a polymerization reaction, in which a polymerization reactor is rotated to perform the polymerization, is practiced. In the polymerization reaction, it is preferable that the polymerization reaction uniformly progresses in all parts of the polymerization reactor. However, there is a case that the polymerization reaction can not uniformly progress because of uneven heat distribution in local parts or minute vibrations applied to the polymerization reactor. In this case, there is a possibility that thickness of the formed polymerization layer becomes different between the part where the polymerization is well progressed and the part where the polymerization is less progressed, by difference of viscosity and polymerization contraction. When the preform obtained by such way is drawn, the problem of the long-period variation in the diameter of the POF is caused. This problem leads a reduction of productivity and a deterioration of optical properties of the products, and cannot be solved by only adjusting the manufacturing conditions such as the drawing condition.

An object of the present invention is to provide a production method of a preform of plastic optical member, which can reduce variation in the diameter of the preform, and a plastic optical fiber with no diameter variation.

### DISCLOSURE OF INVENTION

In order to achieve the above object and other objects, the inventor found below problems by keen examination. One of causes of long-period variation in a fiber diameter is periodical variation in a thickness of an inner clad layer caused by vibrations from rotation of a clad tube, when the inner clad layer is formed by entering polymerizable composition for forming the inner clad layer into the clad tube and rotating the clad tube at high speed while heat polymerization. In addition, there causes variation in a thickness of a core when the core is formed by entering polymerizable composition for forming the core into a reaction tube and rotating the reaction tube at high speed while interfacial gel polymerization. Note that the inventor also found that the rotation speed needs to be high at certain degree (for example 1000 rpm to 5000 rpm), to perform the uniform polymerization.

By further examination, it was found that the periodical variation of the thickness of the inner clad layer or the core, which is caused by vibration in rotating the clad tube or the reaction tube, can be reduced by controlling polymerization behavior to have a high leveling effect in which an increasing speed of viscosity is moderate. However, when a monomer having high thermal reactivity (such as MMA) is used as the polymerizable composition, it is difficult to control polymerization behavior to have the high leveling effect, by generation of instantaneous solidification or the like. Moreover, acrylic resin synthesized from (meth) acrylic acid or esterification compound thereof as the polymerizable composition has superior optical properties so that it is difficult to use other material as a substitution. After examining solution of this problem, the inventor found that when temperature gradient is applied to the clad tube or the reaction tube while the clad tube or the reaction tube containing the monomer having thermal reactivity is rotated at high speed for the polymerization, the polymerization time for completion of the reaction can be changed in the longitudinal direction of the tube. By this change of the polymerization time for completion of the reaction in the longitudinal direction of the tube, the high leveling effect in the polymerization reaction is obtained.

In a production method of a preform of plastic optical member of the present invention, a polymerizable composition is injected into a hollow tube to perform polymerization reaction such that at least one polymer layer is formed on the inner peripheral surface of the hollow tube. In this time, time for polymerization reaction varies in the longitudinal direction of the hollow tube.

It is preferable that the hollow tube is a clad tube. It is preferable that the polymer layer is an inner clad layer and a core is formed on the inner periphery of the inner clad layer. It is also preferable that the time for said polymerization reaction is time for solidifying the polymerizable composition, and a continual temperature gradient is applied to the hollow tube such that a difference of time for solidifying the polymerizable composition is at least 1.2 hours per 1 m length of the longitudinal direction. Note that heat generated in the polymerization reaction is monitored by temperature sensor or the like, so as to detect a state that the heat is reached to the highest temperature, that is, the temperature rise is stopped. In this state, the polymerizable composition is judged as solidified. In addition, the temperature gradient means that a temperature of heat applied to the hollow tube for the polymerization is varied along the longitudinal direction.

It is preferable that a main component of the hollow tube is fluorine resin. It is preferable that a main component of the polymer layer is (meth)acrylic resin. In addition, it is preferable that the core is formed by interfacial gel polymerization, and has a refractive index gradually decreases from the center to the outer periphery.

The present invention includes also a plastic optical fiber obtained by heat-drawing the preform produced from this production method.

According to the production method of a preform of plastic optical member of the present invention, since the polymerizable composition is infused into the hollow tube to perform polymerization reaction such that at least one polymer layer is formed on the inner peripheral surface of the hollow tube, with changing the time for polymerization reaction in the longitudinal direction of the hollow tube, generation of the instantaneous solidification is prevented so that a high leveling effect in the polymerization reaction is obtained. Therefore generation of thickness variation of the polymer layer can be inhibited. Since the time for said polymerization reaction is time for solidifying the polymerizable composition, and a continual temperature gradient is applied to the hollow tube such that a difference of time for solidifying the polymerizable composition is at least 1.2 hours per 1 m length of the longitudinal direction, the leveling effect is further improved.

Since the core is formed on the inner periphery of the polymer layer by interfacial gel polymerization, the preform including the core having the refractive index gradually decreases from the center to the outer periphery can be obtained. When drawing the preform to form the plastic optical fiber, the formed plastic optical fiber has superior optical properties.

The plastic optical fiber of the present invention is obtained by heat-drawing the preform produced from above-described production method. Accordingly, long-period variation of the diameter of the formed plastic optical fiber does not generate, because there is no periodical variation in the thickness of the inner clad layer of the preform. Therefore productivity thereof is increased by reducing production loss. In addition, the obtained plastic optical fiber has long length and uniform diameter and optical properties.

### BRIEF DESCRIPTION OF DRAWINGS

FIG. 1 is a process chart of a production method of a preform of plastic optical member of the present invention;

FIG. 2 is a schematic diagram of a rotational polymerization device for producing the preform; and

FIG. 3 is a cross-sectional view of the preform obtained by the production method of the present invention.

### BEST MODE FOR CARRYING OUT THE INVENTION

The present invention is described in detail with reference to preferred embodiments. These embodiments described below do not limit the scope of the claims of the present invention.

(Core and Inner Clad Layer)

As a raw material of a core and an inner clad layer, it is preferable to select a polymerizable monomer that is easily bulk polymerized. Examples of the raw materials with high optical transmittance and easy bulk polymerization are (meth) acrylic acid esters [(a) (meth)acrylic ester without fluorine, (b) (meth)acrylic ester containing fluorine], (c) styrene type compounds, (d) vinyl esters, or the like. The core may be formed from homopolymer composed of one of these monomers, from copolymer composed of at least two kinds of these monomers, or from a mixture of the homopolymer(s) and/or the copolymer(s). Among them, (meth) acrylic acid ester can be used as a polymerizable monomer.

Concretely, examples of the (a) (meth) acrylic ester without fluorine as the polymerizable monomer are methyl methacrylate (MMA); ethyl methacrylate; isopropyl methacrylate; tert-butyl methacrylate; benzyl methacrylate (BzMA); phenyl methacrylate; cyclohexyl methacrylate, diphenylmethyl methacrylate; tricyclo[5.2.1.0^{2,6}]decanyl methacrylate; adamanthyl methacrylate; isobonyl methacrylate; norbornyl methacrylate; methyl acrylate; ethyl acrylate; tert-butyl acrylate; phenyl acrylate, and the like. Examples of (b) (meth)acrylic ester with fluorine are 2,2,2-trifluoroethyl methacrylate; 2,2,3,3-tetrafluoro propyl methacrylate; 2,2,3,3,3-pentafluoro propyl methacrylate; 1-trifluoromethyl-2,2,2-trifluoromethyl methacrylate; 2,2,3,3,4,4,5,5-octafluoropenthyl methacrylate; 2,2,3,3,4,4,-hexafluorobutyl methacrylate, and the like. Further, in (c) styrene type compounds, there are styrene; α-methylstyrene; chlorostyrene; bromostyrene and the like. In (d) vinylesters, there are vinylacetate; vinylbenzoate; vinylphenylacetate; vinylchloroacetate; and the like. The polymerzable monomers are not limited to the monomers listed above. Preferably, the kinds and composition of the monomers are selected such that the refractive index of the homopolymer or the copolymer in the core is approximately similar or higher than the refractive index in the clad. As the polymer for the raw material, polymethyl methacrylate (PMMA), which is a transparent resin, is more preferable.

When a plastic optical fiber (hereinafter the POF) is used for near infrared ray, the C—H bond in the compound of the core causes absorption loss. By use of the polymer in which the hydrogen atom (H) of the C—H bond is substituted by the deuterium (D) or fluorine (F), the wavelength range to cause transmission loss shifts to a larger wavelength region. Japanese Patent No. 3332922 teaches the examples of such polymers, such as deuterated polymethylmethacrylate (PMMA-d8), polytrifluoroethylmethacrylate (P3FMA), polyhexafluoro isopropyl-2-fluoroacrylate (HFIP 2-FA), and the like. Thereby, it is possible to reduce the loss of transmission light. It is to be noted that the impurities and foreign materials in the monomers that causes dispersion should be sufficiently removed before polymerization so as to keep the transparency of the POF 17 after polymerization.

(Clad)

In order that the transmitted light in the core is completely reflected at the interface between the core and the clad, the material for the clad is required to have smaller refractive index than the core and exhibits excellent fitness to the core. If there is irregularity between the core and the clad, or if the material for the clad does not fit the core, the inner clad layer may be provided between the core and the clad. For example, the inner clad layer, formed on the peripheral surface of the core (inner wall of the tubular clad tube) from the same composition as the matrix of the core, can improve the interface condition between the core and the clad. Instead of the inner clad layer, the clad may be formed such that the matrix of the clad has the same composition as the matrix of the core.

A material having excellent toughness, moisture resistance and heat-resistance is preferable for the clad. For example, a homopolymer or a copolymer of the monomer including fluorine is preferable. As the monomer including fluorine, vinylidene fluoride (VDF) is preferable. It is also preferable to use a fluorine resin obtained by polymerizing one kind or more of polymerizable monomer having 10 mass % of vinylidene fluoride.

In the event of forming the clad of the polymer by melt-extrusion, the viscosity of the molten polymer needs to be appropriate. The viscosity of the molten polymer correlates the molecular weight, especially the weight-average molecular weight. In this preferable embodiment, the weight-average molecular weight is preferably 10,000 to 1,000,000, and more preferably 50,000 to 500,000.

It is also preferable to prevent the core from absorbing water as much as possible. Thus, a polymer with low water absorption is used as the material for the clad. The clad may be formed from the polymer having the saturated water absorption (water absorption) of less than 1.8%. More preferably, the water absorption of the polymer is less than 1.5%, and most preferably less than 1.0%. The outer core layer is preferably formed from the polymer having approximately similar water absorption. The water absorption (%) is obtained by measuring the water absorption after soaking the sample of the polymer in the water of 23° C. for one week, pursuant to the American Society for Testing and Materials (ASTM) D 570.

(Polymerization Initiators)

In polymerizing the monomer to form the polymer as the core, the inner clad layer and the clad, polymerization initiators can be added to initiate polymerization of the monomers. The polymerization initiator to be added is appropriately chosen in accordance with the monomer and the method of polymerization. Examples of the polymerization initiators are peroxide compounds, such as benzoil peroxide (BPO); tert-butylperoxy-2-ethylhexanate (PBO); di-tert-butylperoxide (PBD); tert-butylperoxyisopropylcarbonate (PBI); n-butyl-4,4-bis(tert-butylperoxy)valarate (PHV), and the like. Other examples of the polymerization initiators are azo compounds, such as 2,2′-azobisisobutylonitril; 2,2′-azobis(2-methylbutylonitril); 1,1′-azobis(cyclohexane-1-carbonitryl); 2,2′-azobis(2-methylpropane); 2,2′-azobis(2-methylbutane) 2,2′-azobis(2-methylpentane); 2,2′-azobis(2,3-dimethylbutane); 2,2′-azobis(2-methylhexane); 2,2′-azobis(2,4-dimethylpentane); 2,2′-azobis (2,3,3-trimethylbutane); 2,2′-azobis(2,4,4-trimethylpentane); 3,3′-azobis(3-methylpentane); 3,3′-azobis(3-methylhexane); 3,3′-azobis(3,4-dimethypentane); 3,3′-azobis(3-ethylpentane); dimethyl-2,2′-azobis(2-methylpropionate); diethyl-2,2′-azobis(2-methylpropionate); di-tert-butyl-2,2′-azobis(2-methylpropionate), and the like. Note that the polymerization initiators are not limited to the above substances. More than one kind of the polymerization initiators may be combined.

(Chain Transfer Agent)

The polymerizable composition for the clad, the inner clad layer and the core preferably contain a chain transfer agent for mainly controlling the molecular weight of the polymer. The chain transfer agent can control the polymerization speed and polymerization degree in forming the polymer from the polymerizable monomer, and thus it is possible to control the molecular weight of the polymer. For instance, in drawing the preform to produce the POF, adjusting the molecular weight by the chain transfer agent can control the mechanical properties of the optical member in the drawing process. Thus, adding the chain transfer agent makes it possible to increase the productivity of the optical member.

The kind and the amount of the chain transfer agent are selected in accordance with the kinds of the polymerizable monomer. The chain transfer coefficient of the chain transfer agent to the respective monomer is described, for example, in “Polymer Handbook, 3^{rd} edition”, (edited by J. BRANDRUP & E. H. IMMERGUT, issued from JOHN WILEY & SON). In addition, the chain transfer coefficient may be calculated through the experiments in the method described in “Experiment Method of Polymers” (edited by Takayuki Ohtsu and Masayoshi Kinoshita, issued from Kagakudojin, 1972).

Preferable examples of the chain transfer agent are alkylmercaptans [for instance, n-butylmercaptan; n-pentylmercaptan; n-octylmercaptan; n-laurylmercaptan; tert-dodecylmercaptan, and the like], and thiophenols [for example, thiophenol; m-bromothiophenol; p-bromothiophenol; m-toluenethiol; p-toluenethiol, and the like]. It is especially preferable to use n-octylmercaptan, n-laurylmercaptan, and tert-dodecylmercaptan in the alkylmercaptans. Further, the hydrogen atom on C—H bond may be substituted by the fluorine atom (F) or a deuterium atom (D) in the chain transfer agent. Note that the chain transfer agents are not limited to the above substances. More than one kind of the chain transfer agents may be combined.

(Refractive Index Control Agent)

The refractive index control agent may be preferably added to the polymerizable composition for the core. It is also possible to add the refractive index control agent to the polymerizable composition for the clad. The core having refractive index profile can be easily formed by providing the concentration distribution of the refractive index control agent. Without the refractive index control agent, it is possible to form the core having refractive index profile by providing the profile in the co-polymerization ratio of more than one kind of the polymerizable monomers in the core. However, in consideration of controlling the composition of the copolymer, adding the refractive index control agent is preferable.

The refractive index control agent is referred to as “dopant”. The dopant is a compound that has different refractive index from the polymerizable monomer to be combined. The difference in the refractive index between the dopant and the polymerizable monomer is preferably 0.005 or more. The dopant has the feature to increase the refractive index of the polymer, compared to one that does not include the dopant. In comparison of the polymers produced from the monomers as described in Japanese Patent Publication No. 3332922 and Japanese Patent Laid-Open Publication No. 5-173026, the dopant has the feature that the difference in solution parameter is 7 (cal/cm³)^{1/2} or smaller, and the difference in the refractive index is 0.001 or higher. Any materials having such features may be used as the dopant if such material can change the refractive index and stably exists with the polymers, and the material is stable under the polymerizing condition (such as temperature and pressure conditions) of the polymerizable monomers as described above.

The dopant may be polymerizable compound, and in that case, it is preferable that the copolymer having the dopant as copolymerized component increases the refractive index in comparison of the polymer without the dopant. An example of such copolymer is MMA-BzMA copolymer.

As described in Japanese Patent Publication No. 3332922 and Japanese Patent Laid-Open Publication No. 11-142657, examples of the dopants are benzyl benzoate (BEN); diphenyl sulfide (DPS); triphenyl phosphate (TPP); benzyl n-butyl phthalate (BBP); diphenyl phthalate (DPP); diphenyl (DP); diphenylmethane (DPM); tricresyl phosphate (TCP); diphenylsoufoxide (DPSO); diphenyl sulfide derivative; dithiane derivative. Among them, BEN, DPS, TPP, DPSO, diphenyl sulfide derivative and dithiane derivative are preferable. In order to improve the transparency in a longer wavelength range, it is possible to use the compounds in which the hydrogen atom is substituted by the deuterium. Example of the polymerizable compound is tribromophenyl methacrylate. A polymerizable compound as the dopant is advantageous in heat resistance although it would be difficult to control various properties (especially optical property) because of copolymerization of polymerizable monomer and polymerizable dopant.

It is possible to control the refractive index of the POF by controlling the density and distribution of the refractive index control agent to be mixed with the core. The amount of the refractive index control agent may be appropriately chosen in accordance with the purpose of the optical member. More than one kind of the refractive index control agents can be added.

(Other Additives)

Other additives may be contained in the core, the inner clad layer and the clad so far as the transmittance properties do not decrease. For example, the additives may be used for increasing resistance of climate and durability. Further, induced emissive functional compounds may be added for amplifying the optical signal. When such compounds are added to the monomers, weak signal light is amplified by excitation light so that the transmission distance increases. Therefore, the optical member with such additive may be used as an optical fiber amplifier. These additives may be contained in the core, the inner clad layer and the clad by polymerizing the additives with the monomers.

[Protective Layer Material]

A protective layer is formed on the POF to make a POF code or a POF cable which has increased mechanical strength for easy handling. The material for the protective layer is selected such that the formation of the protective layer does not cause thermal damage (deformation, denaturation, thermal decompression, or the like) to the POF. Thus, the protective layer material should be hardened in reaction at a temperature between (Tg-50)° C. to the glass transition temperature Tg(° C.) of the polymer for the POF. For the purpose of reducing the manufacture cost, the formation period (the period to harden the protective layer material) is preferably between 1 second to 10 minutes, and more preferably between 1 second to 5 minutes. When the POF is composed of plural polymers, Tg is the smallest glass transition temperature among these polymers. When the polymers for POF has the glass transition temperature no more than the normal temperature (such as PVDF, whose glass transition temperature is approximately −40° C.) or do not have glass transition temperature, Tg is the smallest phase transition temperature (melting point, for instance).

Examples of the protective layer materials are ordinary olefin polymers such as polyethylene (PE) and polypropylene (PP), all-purpose polymer such as vinyl chloride and Nylon. It is also possible to apply the following materials that are effective in providing mechanical property (such as bending property) due to high elasticity. Examples of such materials are rubbers as an example of the polymer, such as isoprene type rubber (for example, natural rubber, isoprene rubber and the like), butadiene type rubber (for example, styrene-butadiene co-polymer rubber, butadiene rubber and the like), diene type specific rubber (for example, nitrile rubber, chloroprene rubber and the like), olefine type rubber (for example, ethylene-propylene rubber, acryl rubber, butyl rubber, butylhalide rubber and the like), ether type rubber, polysulfide rubber, urethane rubber and the like.

As the preferable materials for the protective coating, there are liquid rubbers which has fluidity in a room temperature and losses the fluidity by the heating to harden. Concretely, they are polydiene type (standard structure is polyisoprene, polybutadiene, butadiene-acrylonitril co-polymer, polychloroprene and the like), polyolefine type (for example, the standard structure is polyolefine, polyisobutylene and the like), polyether type (for example, the standard structure is poly(oxypropylene) and the like), polysulfide type (for example, the standard structure is poly(oxyalkylenedisulfide) and the like), polysiloxane type (for example, the standard structure is poly(dimethylsiloxane) and the like) and the like.

As the protective layer, there are thermoplastic resin (including a base resin of a master batch), such as the polymer of ethylene, propylene and α-olefin. Examples of such polymer are ethylene homopolymer, ethylene-α-olefin copolymer, ethylene-propylene copolymer, and so forth.

It is also possible to use a master batch in which nonflammable material as coloring agent, including metal hydration product or phosphorus and nitrogen, is added to these thermoplastic resins. The master batch is formed by mixing the resin and higher concentration of functional additive and kneading them. To knead the additive into bulk resin, inorganic compound which is thermally-stable is often selected as the additive. And from perspective of functions, conductive material for prevention of electrical charge, nonflammable material, dye or pigment for coloring is selected as the additive. In often cases, the coloring agent is used. While the master batch is produced, higher concentration of the additive is dispersed. Accordingly, there is a case that addition of dispersing agent or lubricant, or reforming the additive is performed.

It is preferable that inorganic particles as the additives have small size. Especially, if large size particles are in a surface contacting to the POF or outside air, it is possible to damage the POF or to decrease workability.

Kinds of the additives are not limited, but following additives are preferably used. As the conductive materials, there are noble metal particles such as tin, zinc alloy powder and silver. As the nonflammable materials, there are metal hydroxide and the like such as magnesium hydroxide and aluminum hydroxide. As the coloring pigment, there are carbon black, titanic oxide and zirconium oxide. The most preferable is the carbon black which is low cost and antistatic. In addition, when the carbon black is used as the coating material for the POF, disturbance light is well shielded since near-infrared ray is absorbed, and it is prevented that light emitted outside the POF by bending the POF or the like is returned into the POF.

A concentration of the additives in the master batch is no more than 30.0 wt. %, preferably in a range of 5.0 wt. % to 20.0 wt. %, particularly in a range of 10.0 wt. % to 15.0 wt. %. When the concentration of the additives is below 5.0 wt. %, the effect as the master batch cannot be obtained, and when it is over 30.0 wt. %, the master batch becomes brittle and reduces its dispersibility.

A concentration of the additives in the polymer which is the mixture of the master batch and the bulk resin is preferably in a range of 0.10 wt. % to 10.0 wt. %, particularly in a range of 0.15 wt. % to 5.0 wt. %, especially in a range of 0.20 wt. % to 3.0 wt. %. When the concentration of the additives is below 0.10 wt. %, the effect of the additives cannot be obtained, and when it is over 10.0 wt. %, fluidity and toughness of the resin is reduced, which causes resin starve or diameter variation while the coating.

The molecular weight (for example, number-average molecular weight and weight-average molecular weight), the molecular weight distribution, the melting point and the melt flow rate (MFR) of the thermoplastic resin and the master batch are not limited. The MFR is used as for an index of the fluidity of resin, under the flow test (JIS K 7210 1916). Each MFR of them is closer to each other, extruding can be performed more uniformly.

When the melt temperatures of the bulk resin and the master batch are different, flow inside an extruder is uneven (since the extruding amount from a screw is fluctuated). Accordingly, discharge fluctuation becomes large and outer diameter of the POF after coating is varied. Therefore it is preferable that the difference between the bulk resin melting point Ta(° C.) and the master batch melting point Tb(° C.) is small.

Further, thermoplastic elastomers (TPE) can be used. The thermoplastic elastomers have rubber-like elasticity in a room temperature, and are materials which is plasticized at a high temperature and then easily formed. Concretely, there are styrene type TPE, olefine type TPE, vinylchloride type TPE, urethane type TPE, ester type TPE, amide type TPE and the like. Note that the polymers described above are not especially restricted in these elastomers so far as the polymers of the POF, especially of the core can be molded at or below a glass transition temperature Tg, and copolymer or the mixture of the above or other polymers can be used.

Further, a liquid as a mixture of polymer precurser and reactant can be used and hardened by heating, for forming the coating. For example, as disclosed in Japanese Patent Laid-Open Publication No. 10-158353, there is a one-component thermosetting urethane compositions produced from NCO block polymer precurser and fine powder coating amine. Further, as disclosed in International Publication No. WO95/26374, there is a one-component thermosetting urethane compositions produced from NCO containing urethane polymer precurser and solid amine having a less than 20 μm diameter. Further, in order to improve the efficiency, additives may be added, such as a flame retardant, an antioxydant, a radical scavenger, a lubricant and the like, and several sorts of fillers composed of inorganic or organic compounds may be added.

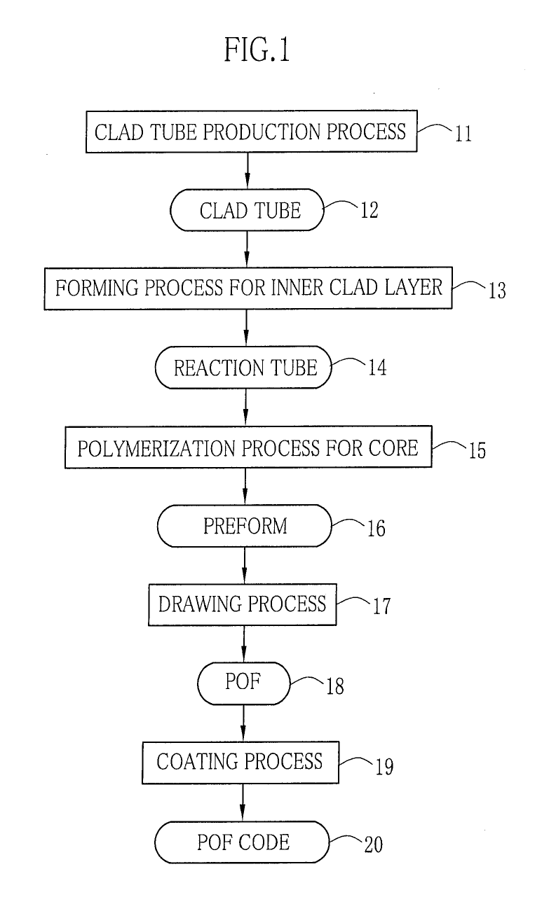

A production method of the preform of the plastic optical member and manufacturing process of the POF from the preform are now explained with reference to FIG. 1. In a clad tube production process 11, the clad tube 12, which is a hollow cylindrical tube, is formed by the extruder. Note that although any of the above-described components can become component of the clad tube 12, PVDF (polyvinylidene fluoride) is preferable for the clad tube 12. The clad tube 12 can be formed by the rotational polymerization method.

Next, a reaction tube 14 is obtained by a forming process for inner clad 13, in which an inner clad layer as the polymer layer is formed on the inner periphery of the clad tube 12. The forming of the inner clad layer is performed by heat polymerization reaction while rotating the clad tube 12. Preferably, the main component of the inner clad layer is PMMA. The forming process for inner clad 13 is explained later in detail. Then the preform 16 is obtained by a polymerization process for core 15. In the polymerization process for core 15, the MMA as the polymerizable composition, DPS (diphenyl sulfide) as the dopant, and other additives (if needed) are entered into the hollow of the reaction tube 14. The core is formed by the interfacial gel polymerization. It is preferable that the interfacial gel polymerization is performed while the reaction tube 14 containing the polymerizable composition is rotated.

From the preform 16, optical members such as the POF and optical lenses are obtained. In a drawing process 17, the preform 16 is heated to a range of 160° C. to 320° C. to be melted. Then an end of the melted preform 16 is drawn to obtain the POF 18. If needed, in a coating process 19, the POF is coated to be a plastic optical fiber (POF) code 20. Note that in the coating process 19, the above-described protective layer material is used as the coating material, preferably polyethylene (PE), polypropylene (PP), or polyvinyl chloride (PVC) is used.

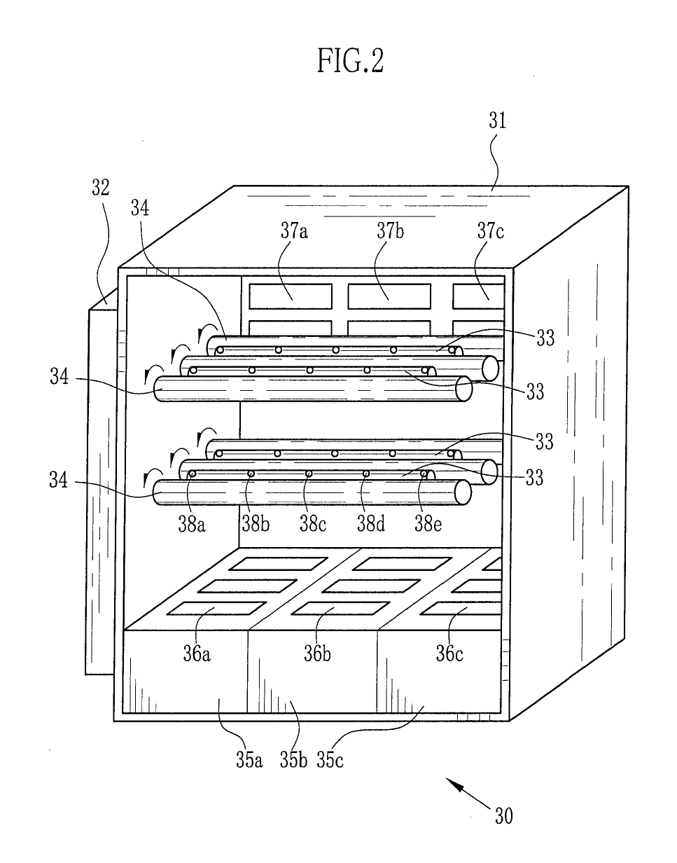

The forming process for inner clad 13 is explained with reference to FIG. 2. The inner clad layer is formed by the rotational polymerization reaction in a rotational polymerization device 30. The rotational polymerization device 30 comprises a main body 31 and a driving section 32. In the main body 31, polymerization reactors 33 and drive rolls 34, whose longitudinal directions are aligned along the horizontal direction, are provided. In FIG. 2, the three drive rolls 34 and the two polymerization reactors 33 positioned between the three drive rolls 34 make one set, and two sets of them are provided in the main body. However, the number and the arrangement of the polymerization reactors 33 and the drive rolls 34 are not limited in FIG. 2.

The polymerization reactor 33 has a pipe shape, and is formed of a rigid material such as SUS or the like. Into the polymerization reactor 33, the clad tube containing the polymerizable composition is inserted. Note that the polymerizable composition is constituted of the polymerizable monomer of the inner clad, the polymerization initiators, the chain transfer agent, and the refractive index control agent and the other additives (if they are needed).

On the bottom of the main body 31, there are fans (not shown) and heaters 35a to 35c. The air inside the main body 31 is inspired into air inlets 36a to 36c, then heated and discharged from air outlets 37a to 37c. Temperature sensors (not shown) are attached to the air outlets 37a to 37c, to be used for controlling the heaters 35a to 35c. According to this circulation of the heated air, inside the main body 31 and the polymerization reactors 33 are heated, and their temperatures are under control. The plural heaters 35a to 35c, the plural air inlets 36a to 36c, the plural air outlets 37a to 37c respectively control the temperature of corresponding area of the polymerization reactor 33 divided along the longitudinal direction. For this purpose, the temperature settings of the heaters 35a to 35c can be individually controlled, and also the sizes of the air inlets 36a to 36c and the air outlets 37a to 37c can be individually controlled. In FIG. 2, there are the three heaters for three sections, which are the heater 35a at the left side, the heater 35b at the center and the heater 35c at the right side of the main body 31. There are also three air inlets 36a to 36c and the three air outlets 37a to 37c for the three sections. However, in the present invention, the number of sections is not limited to three. The number is preferably in a range of 2 to 20, particularly in a range of 3 to 15, especially in a range of 4 to 10.

Temperature sensors 38a to 38e are provided along the longitudinal direction of the polymerization reactor 33, 1 cm above the polymerization reactor 33. The temperature sensors 38a to 38e monitor a temperature gradient along the longitudinal direction of the polymerization reactor 33 in the polymerization reaction, to confirm that there is a continuous and linear temperature gradient. In addition, the temperature sensors 38a to 38e can detect the solidification of the polymerizable composition, that is, the completion of the polymerization reaction by monitoring temperature rise caused in the polymerization reaction, because when the polymerizable composition loses fluidity and solidifies, the generation of heat from the polymerizable composition is stopped, that is, the temperature rise is no longer detected by the temperature sensors 38a to 38e. Thereby the completion of the polymerization reaction can be detected. In FIG. 2, the five temperature sensors 38a to 38e are provided, however, the number thereof is not limited to five. The number is preferably in a range of 2 to 20, particularly in a range of 3 to 15, especially in a range of 4 to 10.

Note that the heating method for the rotational polymerization device 30 is not limited to the circulation of heated air. For example, a heating mechanism may be contained in the drive roll 34. It may be also that a flow passage is provided in the drive roll 34 and heat transmission medium is circulated in the flow passage. In this case, the drive roll has plural sections along the longitudinal direction, each of which can have different temperature among them. Thereby the temperature gradient of the polymerization reactor 33 can be controlled. In addition, there may be a method that each of the left and right walls of the main body 31 has thermal insulation performance which is different each other, to give the polymerization reactor 33 the temperature gradient.

The length of the drive roll 34 is not limited. However, it is preferably in a range of 1.05×L (mm) to 2.00×L (mm), particularly in a range of 1.10×L (mm) to 1.80×L (mm), especially a range of 1.20×L (mm) to 1.60×L (mm), when the length of the clad tube 12 is L (mm).

The set temperature of the heater 35 or the heating temperature of the drive roll 34 is not limited. However, it is preferably in a range of 25° C. to 140° C., particularly in a range of 30° C. to 120° C., especially in a range of 35° C. to 100° C., when the main component of the inner clad layer is PMMA. When the temperature is under 25° C., the reaction is difficult to progress, and when the temperature is over 140° C., bubbles tend to be generated by boiling.

To apply the temperature gradient along the longitudinal direction of the polymerization reactor 33, the set temperature of each of the heaters 35a, 35b, 35c is different each other. If the set temperatures of the heaters 35a to 35c are the same, the inner clad layer is rapidly fixed at the same time along the longitudinal direction thereby it is remained the periodical variation of fluid level caused by the vibration in the rotation. On the other hand, when the temperature gradient is applied, the inner clad layer is gradually fixed from the end portion thereby the periodical variation fluid level is leveled. Accordingly, it can be formed the inner clad layer without periodical variation in its thickness. The difference range of the set temperatures is not limited, however it is preferably in a range of 1° C. to 30° C., particularly in a range of 2° C. to 20° C., especially in a range of 3° C. to 10° C. When the difference is below 1° C., it is possible that there cannot be the efficient difference of the time for completion of the reaction in the longitudinal direction. When the difference is over 30° C., it is possible that a time for forming the inner clad layer is lengthen, which reduces the productivity.

The most preferable temperature gradient is continuous and linear along the longitudinal direction of the clad tube 12. The temperature gradient is monitored by the temperature sensors 38a to 38e. Accordingly, time for the polymerization reaction can be controlled along the longitudinal direction of the clad tube 12. The temperature difference between both ends of the clad tube 12 is need to be selected, in consideration for the diameter and the length of the clad tube 12, and type and polymerization formulation of polymerizable composition for forming the inner clad layer. Thereby the inner clad layer, having an approximately uniform thickness, can be formed on the inner periphery of the clad tube 12.

The drive roll 34 is rotated by a driving device (not shown) of the driving section 32. Accompanying with the rotation of the drive roll 34, the polymerization reactor 33 sandwiched between them are also rotated. The rotation speed is not limited. However, it is preferable in a range of 100 rpm to 5000 rpm, particularly in a range of 500 rpm to 4000 rpm, especially in a range of 1000 rpm to 3000 rpm. When the rotation speed is slower than 100 rpm, a hollow layer is possibly distorted by lack of centrifugal force. When the rotation speed is faster than 5000 rpm, the vibration of the device possibly becomes too increased to stably rotate the polymerization reactor.

To keep the desired temperature in the main body 31, a temperature regulator (not shown) can be provided in the main body 31. Although the temperature in the main body 31 is not limited, it is preferably in a range of 25° C. to 140° C., particularly in a range of 30° C. to 120° C., especially in a range of 35° C. to 100° C. When the temperature is under 25° C., the reaction is difficult to progress, and when the temperature is over 140° C., bubbles tend to be generated by boiling.

The clad tube 12 has the diameter of 10 mm to 60 mm, and the length L (mm) of 300 mm to 2000 mm. The main component of the clad tube 12 is PVDF. Monomethyl methacrylate (MMA), polymerization initiators and chain transfer agent are charged into each of four clad tubes 12, as the polymerizable composition. Then each clad tube 12 is inserted into the corresponding polymerization reactor 33.

The drive roll 34 is rotated to rotate the polymerization reactor 33 at the rotation speed of 100 rpm to 5000 rpm. The set temperature of the heater 35a at the left side is in a range of 25° C. to 138° C., that of the heater 35b at the center is in a range of 26° C. to 139° C., and that of the heater 35c at the right side is in a range of 27° C. to 140° C., to apply the temperature gradient to the polymerization reactor 33. Thereby it is controlled the polymerization speed of the polymerizable composition in the clad tube 12. Note that the temperature difference, which is monitored by the temperature sensors 38a to 38e, is not limited along the longitudinal direction of the polymerization reactor 33. However, the temperature difference is preferably in a range of 0.5° C. to 25.0° C., particularly in a range of 1.0° C. to 20.0° C., especially in a range of 2.0° C. to 15.0° C., per 1 m in the longitudinal direction of the polymerization reactor 33. When the difference is below 0.5° C. per 1 m, it is possible that there cannot be the efficient difference of the time for completion of the reaction in the longitudinal direction. When the difference is over 15° C. per 1 m, it is possible that a time for forming the inner clad layer is lengthen, which reduces the productivity.

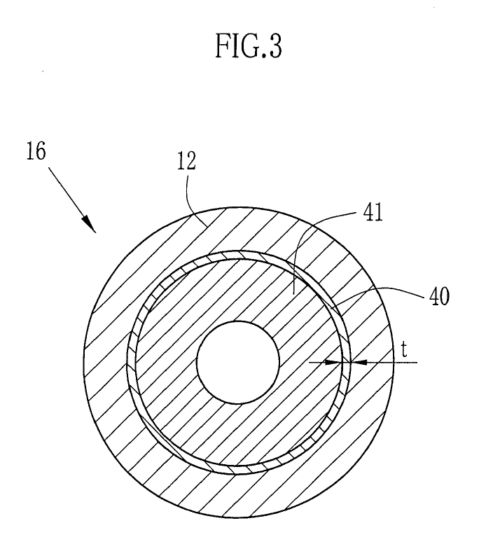

As shown in FIG. 3, when the clad tube 12 has the outer diameter of Ø20 mm and the inner diameter of Ø19 mm, the inner clad layer 40, whose thickness t (mm) is 3.8 mm, can be formed by 2 hours to 30 hours rotational polymerization. Note that the thickness t (mm) of the inner clad layer 40 is not limited to the above value. When the inner diameter of the clad tube 12 is D (mm), the thickness t (mm) of the inner clad layer 40 is preferably in a range of 0.05×D (mm) to 0.42×D (mm), particularly in a range of 0.07×D (mm) to 0.37×D (mm), especially in a range of 0.10×D (mm) to 0.32×D (mm). If the thickness t (mm) of the inner clad layer 40 is smaller than 0.05×D (mm), it may be difficult to form the uniform inner clad layer 40 because of lack of fluid volume of the polymerizable composition. If the thickness t (mm) of the inner clad layer 40 is larger than 0.42×D (mm), it is possible that inside the inner clad layer 40 (hollow portion), into which the polymerizable composition to be the core is entered, is partially closed.

The time difference in the polymerization reaction is preferably at least 1.2 hours, particularly at least 1.5 hours, especially at least 1.7 hours per 1 m in the longitudinal direction of the clad tube 12. Although the upper limit of the time difference is not limited, it is preferably no more than 3 hours, from the aspect of productivity. When the time difference is below 0.5 hours, the temperature difference may be insufficient between the both ends of the clad tube 12 to generate the sufficient time difference for completion of the reaction along the longitudinal direction. Accordingly, it is possible to generate high polymerization heat when using some materials, which causes local viscosity rise at unreacted area, and thereby it is possible to cause unevenness, such as undulation, in the inner peripheral surface of the inner clad layer 40. Note that if polymer precurserization is performed, the time difference in the polymerization reaction is determined with taking degree of the polymer precurserization into account.

Fluctuation range of the thickness t of the inner clad layer 40 is no more than 0.3%. In a preferable forming condition, the fluctuation range is no more than 0.2%, and in the most preferable forming condition, the fluctuation range is no more than 0.1%. The preform 16 is obtained by forming the core 41 inside the inner clad layer 40, in interfacial gel polymerization or the like.

A system to transmit optical signals through the POF 18, the POF code 20 and the POF cable which are formed from the POF 18 comprises optical signal processing devices including optical components, such as a light emitting element, a light receiving element, an optical switch, an optical isolator, an optical integrated circuit, an optical transmitter and receiver module, and the like. Such system may be combined with other POFs. Any know techniques can be applied to the present invention. The techniques are described in, for example, “‘Basic and Practice of Plastic Optical Fiber’ (issued from NTS Inc.)”, “‘Optical members can be Loaded on Printed Wiring Assembly, at Last’ in Nikkei Electronics, vol. Dec. 3, 2001”, pp. 110-127”, and so on. By combining the optical member according to with the techniques in these publications, the optical member is applicable to short-distance optical transmission system that is suitable for high-speed and large capacity data communication and for control under no influence of electromagnetic wave. Concretely, the optical member is applicable to wiring in apparatuses (such as computers and several digital apparatuses), wiring in trains and vessels, optical linking between an optical terminal and a digital device and between digital devices, indoor optical LAN in houses, collective housings, factories, offices, hospitals, schools, and outdoor optical LAN.

Further, other techniques to be combined with the optical transmission system are disclosed, for example, in “‘High-Uniformity Star Coupler Using Diffused Light Transmission’ in IEICE TRANS. ELECTRON., VOL. E84-C, No. 3, MARCH 2001, pp. 339-344”, “‘Interconnection in Technique of Optical Sheet Bath’ in Journal of Japan Institute of Electronics Packaging., Vol. 3, No. 6, 2000, pp. 476-480”. Moreover, there are am optical bus (disclosed in Japanese Patent Laid-Open Publications No. 10-123350, No. 2002-90571, No. 2001-290055 and the like); an optical branching/coupling device (disclosed in Japanese Patent Laid-Open Publications No. 2001-74971, No. 2000-329962, No. 2001-74966, No. 2001-74968, No. 2001-318263, No. 2001-311840 and the like); an optical star coupler (disclosed in Japanese Patent Laid-Open Publications No. 2000-241655); an optical signal transmission device and an optical data bus system (disclosed in Japanese Patent Laid-Open Publications No. 2002-62457, No. 2002-101044, No. 2001-305395 and the like); a processing device of optical signal (disclosed in Japanese Patent Laid-Open Publications No. 2000-23011 and the like); a cross connect system for optical signals (disclosed in Japanese Patent Laid-Open Publications No. 2001-86537 and the like); a light transmitting system (disclosed in Japanese Patent Laid-Open Publications No. 2002-26815 and the like); multi-function system (disclosed in Japanese Patent Laid-Open Publications No. 2001-339554, No. 2001-339555 and the like); and various kinds of optical waveguides, optical branching, optical couplers, optical multiplexers, optical demultiplexers and the like. When the optical system having the optical member according to the present invention is combined with these techniques, it is possible to construct an advanced optical transmission system to send/receive multiplexed optical signals. The optical member according to the present invention is also applicable to other purposes, such as for lighting, energy transmission, illumination, and sensors.

### Experiments

The present invention will be described in detail with reference to Experiments (1)-(2) as the embodiments of the present invention and Experiments (3)-(5) as the comparisons. The materials, contents, operations and the like will be changed so far as the changes are within the spirit of the present invention. Thus, the scope of the present invention is not limited to the Experiments described below. The description below explains Experiment (1) in detail. Regarding Experiments (2)-(5), the portions different from Experiment (1) will be explained.

### Experiment 1

The clad tube 12 of PVDF (polyvinylidene-fluoride) was produced by extrusion molding, to have Ø20 mm, 0.5 mm thickness, and 905 mm length. Into the clad tube 12, approximately 200 g of MMA (methyl methacrylate) including 0.024 mol % of dimethyl-2,2-azobis(2-methyl propionate) (V-601) as the polymerization initiator and 0.2 mol % of n-lauryl mercaptan as the chain transfer agent, were injected. Then the clad tube 12 was inserted into a SUS pipe as the polymerization reactor 33.

Next, the forming process for inner clad layer 13 was performed. The set temperature of the heater 35a at the left was 56° C., that of the heater 35b at the center was 58° C., and that of the heater 35c at the right was 60° C. Accordingly, the continuous and approximately linear temperature gradient from 57° C. to 60° C. was applied to the longitudinal direction of the clad tube 12 in the polymerization reaction. The polymerization reaction was performed with rotating the clad pipe 12 at 500 rpm to 3000 rpm. As a result, the reaction tube 14, including the inner clad layer 40 with 3.8 mm of the thickness t (mm), was obtained.

The amount of time for completing the polymerization reaction was approximately 15.8 hours at the left end of the clad tube 12 where the environmental temperature was 57° C., and approximately 14.1 hours at the right end thereof where the environmental temperature was 60° C. in the longitudinal direction thereof. The difference between them was 1.7 hours, and it was confirmed that the difference of the time for completion of the reaction was continuous along the longitudinal direction of the clad tube 12. The difference of the time for completion of the reaction was detected by monitoring the heat in the polymerization reaction with use of the five temperature sensors 38a to 38e in the rotational polymerization device 30, which are arranged along the longitudinal direction of the polymerization reactor 33 at every 20 cm distance.

Into the reaction tube 14, a polymerizable composition which was approximately 100 g of MMA including 0.04 mol % of dimethyl-2,2-azobis(2-methyl propionate) (V-601), 0.2 mol % of n-lauryl mercaptan, and 7 wt. % of DPS (diphenyl sulfide), was injected. Then the reaction tube 14 was inserted into the SUS pipe as the polymerization reactor 33. It was rotated at 500 rpm to 2000 rpm for the polymerization in 70° C. for 5 hours, 90° C. for 5 hours and then 120° C. for 24 hours, to form the core 41 thereby the preform 16 was produced. The preform 16 was putted in a furnace where the temperature was 220° C. Then the preform 16 was drawn at 15 m/min drawing speed, to obtain the POF 18 with 319 μm diameter. The POF 18 was the graded index plastic optical fiber (GI-POF). In Experiment 1, the periodical variation was below 10 μm in the thickness of the inner clad layer 40, and that was also below 10 μm in the diameter of the POF 18. The periodical variation of the thickness of the inner clad layer 40 was measured by a high-precision contact-type digital displacement sensor (AT-V of KEYENCE CORPORATION). The periodical variation of the diameter of the POF 18 was measured by a digital micrometer (LS-7000 of KEYENCE CORPORATION).

### Experiment 2

Experiment 2 was performed in the same condition as Experiment 1, except that the temperature in the polymerization was higher than that in Experiment 1, for increasing the time for completion of the reaction in the forming process for inner clad layer 13. The set temperature of the heater 35a at the left was 64° C., that of the heater 35b at the center was 67° C., and that of the heater 35c at the right was 70° C. Accordingly, the continuous and approximately linear temperature gradient from 65° C. to 70° C. was applied to the longitudinal direction of the clad tube 12 in the polymerization reaction. Also in Experiment 2, the periodical variation was below 10 μm in the thickness of the inner clad layer 40, and that was also below 10 μm in the diameter of the POF 18.

The amount of time for completing the polymerization reaction was approximately 7.6 hours at the left end of the clad tube 12 where the environmental temperature was 65° C., and approximately 6.5 hours at the right end thereof where the environmental temperature was 70° C. in the longitudinal direction thereof. The difference between them was 1.2 hours, and it was confirmed that the difference of the time for completion of the reaction was continuous along the longitudinal direction of the clad tube 12.

### Experiment 3

Experiment 3 was performed in the same condition as Experiment 1, except that all the three heaters 35a to 35c were set at 60° C. such that the temperature of the clad pipe 12 was constant at 60° C. along the longitudinal direction. In the produced reaction tube 14, the thickness of the inner clad layer 40 had 40 μm of the variation in approximately 1 cm period. There was no difference in the time for completion of the reaction along the longitudinal direction of the clad tube 12. The preform 16 was obtained from the reaction tube 14, and then the preform 16 was drawn to be the POF 18. The periodical variation was 60 μm in the diameter of the POF 18.

### Experiment 4

Experiment 4 was performed in the same condition as Experiment 2, except that all the three heaters 35a to 35c were set at 70° C. such that the temperature of the clad pipe 12 was constant at 70° C. along the longitudinal direction. In the produced reaction tube 14, the thickness of the inner clad layer 40 had 50 μm of the variation in approximately 1 cm period. There was no difference in the time for completion of the reaction along the longitudinal direction of the clad tube 12. The preform 16 was obtained from the reaction tube 14, and then the preform 16 was drawn to be the POF 18. The periodical variation was 75 μm in the diameter of the POF 18.

### Experiment 5

Experiment 5 was performed in the same condition as Experiment 1, except that the polymerizable composition for the inner clad layer 40 included 0.036 mol % of dimethyl-2,2-azobis (2-methyl propionate) as the polymerization initiator, and that the temperature in the polymerization was higher than that in Experiment 1, for increasing the time for completion of the reaction in the forming process for inner clad layer 13. The set temperature of the heater 35a at the left was 64° C., that of the heater 35b at the center was 67° C., and that of the heater 35c at the right was 70° C. Accordingly, the continuous and approximately linear temperature gradient from 65° C. to 70° C. was applied to the longitudinal direction of the clad tube 12 in the polymerization reaction. However in the produced reaction tube 14, the thickness of the inner clad layer 40 had 15 μm of the slight variation in approximately 1 cm period. The amount of time for completing the polymerization reaction was approximately 6.0 hours at the left end of the clad tube 12 where the environmental temperature was 65° C., and approximately 5.0 hours at the right end thereof where the environmental temperature was 70° C. in the longitudinal direction thereof. The difference between them was 1 hours. The preform 16 was obtained from the reaction tube 14, and then the preform 16 was drawn to be the POF 18. The periodical variation was 20 μm in the diameter of the POF 18.

In Table 1, the conditions and the results of these experiments are shown for evaluation. The periodical variation in the thickness of each of the inner clad layer 40 and the diameter of the POF 18 is evaluated as excellent (E) when this was below 10 μm, as acceptable (A) when this was 10 μm to below 30 μm, and as bad (B) when this was at least 30 μm.

TABLE 1

| | Td | Api | Dpr | | |
|---|---|---|---|---|---|
| | (° C.) | (mol %) | (hr) | Pvi | Pvp |
| Ex. 1 | 57~60 | 0.024 | 1.7 | E | E |
| Ex. 2 | 65~70 | 0.024 | 1.2 | E | E |
| Ex. 3 | 60 | 0.024 | 0 | B | B |
| Ex. 4 | 70 | 0.024 | 0 | B | B |
| Ex. 5 | 65~70 | 0.036 | 1.0 | A | A |

Td: temperature distribution of the clad tube 12
Api: amount of the polymerization initiator
Dpr: difference of required time for completing the polymerization reaction
Pvi: periodical variation in the thickness of the inner clad layer 13
Pvp: periodical variation in the diameter of the POF 18

Various changes and modifications are possible in the present invention and may be understood to be within the present invention.

### INDUSTRIAL APPLICABILITY

The present invention is preferably applied to plastic optical members, such as an optical fiber, an optical lens, an optical waveguide and the like, which are used for optical communication, illumination and the like.

1. A production method of a preform of plastic optical member including a hollow pipe and at least one polymer layer, in which a polymerizable composition is in said hollow tube to perform polymerization reaction such that said polymer layer is formed on an inner peripheral surface of said hollow tube, time for said polymerization reaction varying according to the position in the longitudinal direction of said hollow tube.

2. A production method of a preform of plastic optical member claimed in claim 1, wherein said hollow tube is a clad tube for totally reflecting light entered into said preform at an interface to said polymer layer.

3. A production method of a preform of plastic optical member claimed in claim 1, wherein said polymer layer is an inner clad layer which has a higher refractive index than said clad tube, and a core, for transmitting light entered into said preform, being formed on an inner periphery of said inner clad layer.

4. A production method of a preform of plastic optical member claimed in claim 1, wherein said time for said polymerization reaction is time for solidifying said polymerizable composition, a continual temperature gradient being applied to said hollow tube such that a difference of said time for solidifying said polymerizable composition is at least 1.2 hours per 1 m length of said longitudinal direction.

5. A production method of a preform of plastic optical member claimed in claim 1, wherein a main component of said hollow tube is fluorine resin.

6. A production method of a preform of plastic optical member claimed in claim 1, wherein a main component of said polymer layer is (meth)acrylic resin.

7. A production method of a preform of plastic optical member claimed in claim 3, wherein said core is formed by interfacial gel polymerization, and has a refractive index which is gradually decreases from the center to the outer periphery thereof.

8. A plastic optical fiber obtained by heat-drawing said preform produced from said production method claimed in claim 1 to 7.
